(19) United States
(12) Patent Application Publication
(10) Pub. No.: US 2012/0068930 A1
(43) Pub. Date: Mar. 22, 2012

(54) MOUSE DEVICE

(76) Inventor: Shigeru Mizutani, Tokyo (JP)

(21) Appl. No.: 13/257,563

(22) PCT Filed: Mar. 26, 2010
(86) PCT No.: PCT/JP2010/002225

§ 371 Date: Dec. 5, 2011

(30) Foreign Application Priority Data
Mar. 27, 2009 (JP) 2009-079248

(51) Int. Cl. G06F 3/033

(52) U.S. Cl. 345/163

(57) ABSTRACT

A grip portion 1 has substantially conical shape having a contour tilted, its bottom face is opened and a fastening portion 3 is formed around the edge of the opening. The sliding portion 2 is coupled to the lower part of the grip portion 1, has a gradual convex surface formed at the bottom-face side, and the convex surface contacts a floor surface and slides thereon. The sliding portion 2 is provided with a receiving portion of a battery or a weight 6, and the top face coupled to the grip portion 1 is in an opened tray-like shape. A sensor hole 7 is formed in the center of the bottom of the sliding portion 2, and another fastening portion 3 is formed around the opening. The grip portion 1 is overlaid on the sliding portion 2 and engaged by respective fastening portions 3.

### TECHNICAL FIELD

The present invention relates to a mouse device that moves a pointer displayed on a display screen, and more specifically, a mouse device including a restorable and tiltable grip portion which is self-supporting even if a hand is released therefrom.

### RELATED ART

Since Douglas Carl Engelbart introduced the first mouse device in 1961, a mouse device as a typical pointing device has taken a role of associating a pointer in a computer screen with motion of a hand. While iconographies have been introduced into a computer screen which was initially consisted with only character strings and the world close to the reality has been built in the computer screen, such pointing device has been developed as an extraordinary effective device.

However, as shown in FIG. 13, when an elbow is fixed and a mouse device 51 is operated only by a hand with wrist flexibility, the mouse device 51 can be moved about eight centimeters in the lateral direction by moving the hand transversely, but can be moved one to two centimeters at maximum in the back-and-forth direction by bending and stretching a proximal interphalangeal (PIP) joint and a distal interphalangeal (DPI) joint. A horizontally long ellipse indicated by oblique lines is a slidable range form 52 of the mouse device 51.

As shown in FIG. 14, when a display screen range form 53 of a typical computer having an aspect ratio of about 1:1.5 is overlaid on the slidable range form 52 of the mouse device having an aspect ratio of about 1:4 for comparison, both forms are largely different from each other.

Moreover, as shown in FIG. 15, there is no case in which a movable space for retracting the mouse device is purposefully provided except a case in which the mouse device itself is small in size and thus a space is incidentally present behind the mouse device up to the wrist. When such a movable space is not present, it is unable to move the mouse device backward as it is.

Hence, in order to further move the mouse device, as shown in FIG. 16, an action of moving the elbow backward is further required. In this case, an action of putting up the wrist and pushing or pulling back the elbow mobilizes the muscle from the upper arm to the shoulder. This makes various muscles of the upper body strained in order to maintain the balancing of the whole body.

This is affected by the fact that the lightness/heaviness of a motion of a human body depends on the ratio of the core body to the terminal portion working for such motion. For example, a motion such that a SUMO wrestler pushes out an opponent to the exterior of the SUMO ring is carried out by mobilizing the muscles of the whole body around his lower back, but a fingertip is sufficient for hitting a ping-pong ball. Conversely, at least muscles from a hand to an upper arm must work in order to throw a basketball. In the case of an operation to an information device, since the result relating to a weight is not requisite, when the appropriate motion can be achieved, it is more efficient with less strain for body to increase the motion ratio of a body part close to the terminal portion.

In comparison with the mouse devices, works by writing instruments used by the humankind for usual office works require to use, as shown in FIG. 17, a thumb, an index finger, and a middle finger to hold a shaft, and a pen tip or a tip is operated by the bending and stretching of the wrist and PIP joint 61. Accordingly, the work is freely enabled in the back-and-forth and lateral directions even if the wrist is put down on a table, and a portion from an elbow to a shoulder and a body are free from such work.

Hence, pointing devices which have a writing-instrument-like grip portion and which are held like a writing instrument such as a pen tablet, a pen mouse 71 shown in FIG. 18 and a pen-gripping mouse 72 shown in FIG. 19 have been developed and commercially available, (see, for example, JP 10-269017 A; JP 2000-132327 A; and JP 11-345079 AA).

In addition, there are other examples of pointing devices that are not of a pensile type, such as a joy stick often used for a game device, a touch pad and pointing stick used for a laptop computer, a track ball which allows a ball to be rotated by a finger without sliding it like a mouse device, and a pointing device that is wore by a finger (see, for example, JP 2008-529153).

A pen tablet and the pen-type mouse 71 that have a writing-instrument-like grip portion have a better gripping posture in comparison with mouse devices, but are not widely generalized instead of the mouse devices. This is basically because of following two reasons.

The first reason is that since the operations of the pointing device and other tool like a keyboard are mixed in a computer work, a mouse-type form that is to be switched frequently has better readiness and stability for starting an operation in comparison with a pen-type form. That is, the mouse-type form can be easily held by extending an arm roughly to the proximity of such a pointing device even if it is not visually recognized sufficiently, on the contrary the pen-type form is required to be held to raise such a pointing device. Moreover, after holding such pointing device, it is necessary to check the direction of the tip. Furthermore, since a built-in sensor is activated upon being held by a hand, a correction of a pointer position is necessary for each time. In addition, since other writing instruments are also disposed on a table in many cases, a operation of selecting the pen-type pointing device among them is also required.

The second reason is that the pen-type pointing devices are made as lightweight due to their application, a contact thereof to a surface of the desk is narrow and thus a friction becomes small, so that when operation portions, such as a click button and a scroll wheel, are depressed and rotated, the grip portion provided for such a pen-type pointing device is affected by such a depression, often bringing about an unexpected result. In the case of a mouse device, an operation is given through a portion supported by a sliding plane 40 (see FIG. 15), so that such an operation hardly affects the mouse. However, in the case of the pen-type pointing device, it is necessary to support the pen-type pointing device with an opposite finger of the same hand at the time of depression like clicking. Hence, a pen-type pointing device operation requires a careful and delicate fingertip operation.

Moreover, according to the pen-gripping mouse device 72, an operation of holding the mouse and raising thereof is not required, but when a user attempts to move the shaft like a writing instrument, the tilted angle of the shaft is fixed, so that the shaft cannot be moved by using a hand and finger joints. Hence, an operation of moving the elbow back and forth like the conventional mouse devices is required. In addition, there is a possibility that the pen-gripping mouse device may fall down in an operation environment in which a keyboard, etc., is also present, and thus an operator should be careful.

Furthermore, the joy stick, the pointing stick, the touch pad, the track ball, and the one wore by a fingertip which are not the writing-instrument type have respective advantages, such as an entertainment characteristic, and a compact property, but are not superior from the mouse device in general operability.

The present invention has been made in order to overcome the above-explained technical issue, and it is an object of the present invention to provide a mouse device that can be moved in a wide back-and-forth slidable range by a compact operation through bending and stretching of a wrist and a finger joint without a need of moving respective positions of the wrist and an elbow. Moreover, it is another object of the present invention to provide a mouse device which needs no holding and raising operations and a careful procedure required for a typical pen-type mouse device and which realizes a quick work up to the beginning of an operation by a single step. Furthermore, it is the other object of the present invention to realize a stable operation of a click button and a scroll wheel.

### SUMMARY OF INVENTION

The present invention provides a mouse device which includes a sensor that moves a pointer displayed on a display screen and which is operated in order to move the sensor on a plane, and the mouse device includes: a sliding surface having the sensor exposed; and a grip portion which is coupled to an upper part of the sliding surface when the sliding surface is disposed in a planar direction and which is held by a user, the sliding portion has a convex surface formed at a bottom face thereof, and the grip portion is in a substantially conical shape, an axis of a substantive conic is tilted relative to the bottom face of the sliding portion.

In a preferred embodiment of the present invention, the mouse device further includes a support which abuts the sliding portion to support the sliding portion, in which the support is a member formed so as to close a gap between the convex surface that forms the bottom of the sliding portion and a sliding plane, and is provided together with or separately from the sliding portion.

According to the present invention employing the above-explained configuration, there is provided a mouse device which allows a user to cover a motion of the sliding portion without putting up a wrist and moveing an elbow back and forth like conventional mouse-type pointing devices, and which realizes a slidable range form more similar to the aspect ratio of a display screen and having a little difference therefrom. Accordingly, the arm and the shoulder of the user are free from the strain, thereby reducing a fatigue and the occurrence of tendon sheath inflammation.

Moreover, in the case of a combination with a keyboard and other devices, a operation of holding, raising and settling a pensile shaft in order to maintain a work posture becomes unnecessary which are required for a pen tablet and a pen-type mouse device, thereby making the work smooth. Furthermore, a sensitive operation required for a click button and a scroll wheel on an unstable pensile shaft can be eliminated.

Still further, the bottom of the sliding portion is a convex surface which makes a moving portion and a deformable portion unnecessary, and a whole body can be integrally configured, thereby reducing the occurrence of a defect.

### BRIEF DESCRIPTION OF DRAWINGS

FIG. 1 is a cross-sectional view of a mouse device according to a first embodiment of the present invention;

FIG. 2 is an exemplary diagram showing a configuration of a click button of the mouse device according to the first embodiment of the present invention;

FIG. 3 is an exemplary diagram showing how the mouse device is used according to the first embodiment of the present invention;

FIG. 4 is a conceptual diagram of the mouse device according to the first embodiment of the present invention;

FIG. 5 is a diagram showing a mechanism how the mouse device is slid according to the first embodiment of the present invention;

FIG. 6 is a diagram showing the mechanism how the mouse device is slid according to the first embodiment of the present invention;

FIG. 7 is a diagram showing the mechanism how the house device is slid according to the first embodiment of the present invention;

FIG. 8 is a conceptual diagram showing a mouse device according to a second embodiment of the present invention;

FIG. 9 is a cross-sectional view showing the mouse device according to the second embodiment of the present invention;

FIG. 10 is a perspective view showing how the mouse device is used according to the second embodiment of the present invention;

FIG. 11 is an exemplary diagram showing a configuration of a support portion of a mouse device according to another embodiment;

FIG. 12 is an exemplary diagram showing a configuration of a support portion of a mouse device according to the other embodiment;

FIG. 13 is a diagram showing a slidable range form of a conventional mouse device;

FIG. 14 is a diagram for comparing the slidable range form of the conventional mouse device with a display range form;

FIG. 15 is a diagram showing a movable space of the conventional mouse device;

FIG. 16 is a diagram showing how the conventional mouse device is slid;

FIG. 17 is a diagram showing an example way how a conventional writing instrument is used;

FIG. 18 is a diagram showing an example configuration of a conventional pen-type mouse device and an example way how such mouse device is used; and

FIG. 19 is a diagram showing an example configuration of a conventional pen-gripping mouse device and an example way how such mouse device is used.

### BEST MODE FOR CARRYING OUT THE INVENTION

### Embodiments

### 1. First Embodiment

### [1.1 Configuration]

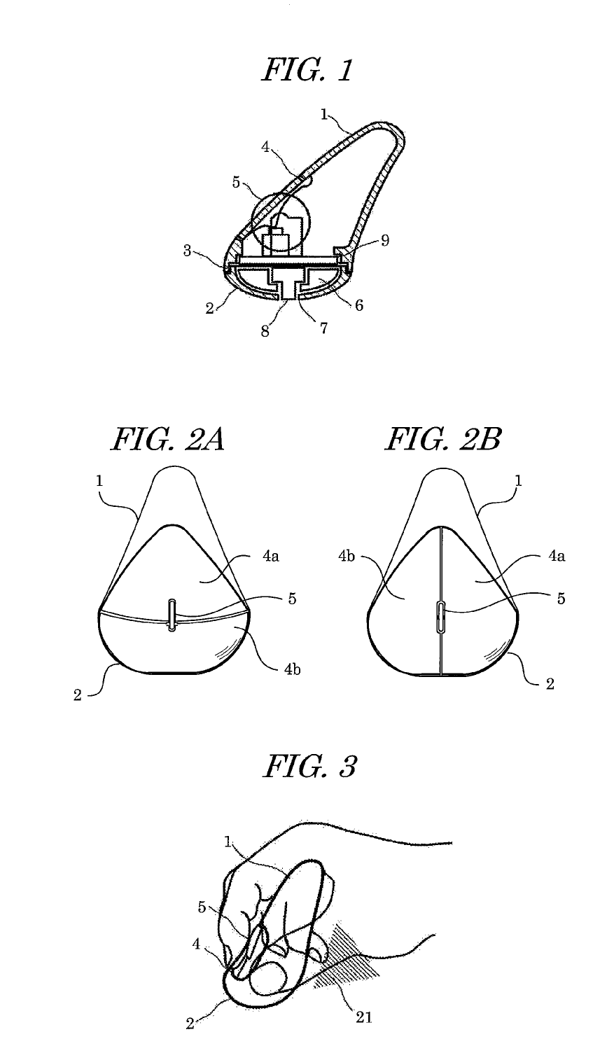

Next, an explanation will be given of a configuration of a mouse device according to a first embodiment of the present invention with reference to FIG. 1. The major feature of the present invention is a corresponding function relating to a form on the human engineering between fingers of an operator and a holding-sliding operation given to a mouse device, so that an explanation for an electronic mechanism as a pointing device will be omitted.

As shown in FIG. 1, a mouse device according to the first embodiment mainly includes a grip portion 1 gripped by a user, a sliding portion 2 in a predetermined shape which is coupled to the lower part of the grip portion 1 and which slides on a floor surface, and a general mouse driving mechanism including a sensor provided inside the contour of the mouse device defined by the grip portion 1 and the sliding portion 2, a pointing device unit 9, and the like.

More specifically, as shown in FIG. 1, the grip portion 1 is in a substantially conical shape which has an oblique cone shape and which also has a hollow thereinside, the bottom face thereof is opened, and a fastening portion 3 coupled to the sliding portion 2 is formed at the edge of the opening. Moreover, the grip portion 1 has an opening formed in the upper side face thereof in a cross-sectional view shown in FIG. 1 for a click button 4 and a scroll wheel 5.

The sliding portion 2 is coupled to the lower part of the grip portion 1, and has a gradual convex surface which is formed at the bottom-face side and which contacts the floor surface and slides thereon. The sliding portion 2 is provided with a receiving portion that receives a battery or a weight 6 thereinside, and the top face coupled to the grip portion 1 is in an opened tray-like shape. The sliding portion 2 has a sensor hole 7 formed in the center of the bottom face, and another fastening portion 3 that is coupled to the edge of the opening of the bottom face of the grip portion 1 is formed around the opening of the top face. When the grip portion 1 is overlaid on the sliding portion 2, and respective fastening portions 3 thereof are engaged with each other, both portions are combined together in the vertical direction, thereby configuring a mouse device.

As the mouse driving mechanism, the battery or the weight 6 is placed in the receiving portion of the sliding portion 2, and the sensor unit 8 is attached to the sensor hole 7 so as to be exposed therefrom. Moreover, the pointing device unit 9 is placed inside the grip portion 1 so that the click button 4 and the scroll wheel 5 are exposed from the upper side face of the grip portion 1.

According to the mouse device of the present embodiment, various layouts and configurations of the click button 4 and the scroll wheel 5 are expected as shown in FIG. 2. FIG. 2 is an exemplary diagram showing the left side of FIG. 1, i.e., the planar appearance of the mouse device provided with the click button 4 and the scroll wheel 5 as viewed from the front.

As shown in FIG. 2A, the most appropriate illustrative layout and configuration of the click button 4 and the scroll wheel 5 of the mouse device according to the present embodiment have a first click button 4a (corresponding to the left click button of a typical mouse device) and a second click button 4b (corresponding to the right click button of the typical mouse device) disposed in the vertical direction, and the scroll wheel 5 is provided in the vertical direction so as to traverse the center positions of the first and second click buttons 4a and 4b. More specifically, the click button 4 is provided along the contour of the grip portion 1 that has an oblique substantially conical contour, and as shown in FIG. 2A, is in dew (liquid droplet) like shape as a whole. That is, the click button 4 symmetrically extends in the horizontal direction from the front part of the mouse device, and includes the second click button 4b at the bottom-face side of the dew shape at the bottom of the sliding portion 2, and the first click button 4a provided above the second click button 4b.

The layout and configuration of the click button 4 and the scroll wheel 5 are not limited to the above-explained example, and for example, as shown in FIG. 2B, a configuration may be employed in which the first click button 4a and the second click button 4b of the click button 4 are disposed in the horizontal direction. Moreover, in the case of FIG. 2A, in order to accomplish the uniformity of a design of the surface of the mouse device, the click button 4 has a contour in a dew shape, but the shape thereof is not limited to the above-explained example as long as the first and second click buttons are arranged side by side in the vertical direction and extend symmetrically in the horizontal direction from the front of the mouse device.

### [1.2 Working and Advantage]

The mouse device employing the above-explained configuration according to the first embodiment operates as follows.

When the mouse device of the first embodiment is used, as shown in FIG. 3, the grip portion 1 is held by a fourth finger and a little finger from the lower external direction, by an index finger and a middle finger from the upper direction, and by a thumb from the lateral internal direction.

When the mouse device is moved backward, the sliding portion 2 is retracted in a provided movable space 21. Moreover, when the mouse device is moved forward, the sliding portion 2 is pushed in the movable space 21. The grip portion 1 is tilted in both cases in which the mouse device is moved forward or is moved backward.

Moreover, the click button 4 and the scroll wheel 5 on the upper face are operated by the index finger and the middle finger. More specifically, the first click button 4a corresponding to the left click button of a typical mouse device can be depressed by the index finger, and the second click button 4b corresponding to the right click button of the typical mouse device can be depressed by the middle finger. Alternatively, both first and second click buttons 4a and 4b can be depressed while the position of the index finger is changed in the vertical direction. Moreover, the scroll wheel 5 provided in the vertical direction so as to traverse the center positions of the first and second click buttons 4a and 4b can be rotated by the index finger.

FIG. 3 shows a condition in which the mouse device is held by the right hand of the user and the click button 4 and the scroll wheel 5 are operated by fingers of the right hand. According to the mouse device of the present embodiment, the first and second click buttons 4a and 4b are disposed in the vertical direction of the mouse device so as to extend symmetrically in the horizontal direction from the front of the mouse device, respectively, and the scroll wheel 5 is provided in the vertical direction so as to traverse the center positions of the first and second click buttons 4a and 4b. Hence, there is no difference in the horizontal direction in the layout and the configuration of the click button 4 and the scroll wheel 5, and the user does not feel any difference in an operating feeling even if the mouse device is operated by either of the right hand and the left hand unlike the conventional mouse devices having the click buttons disposed in the horizontal direction.

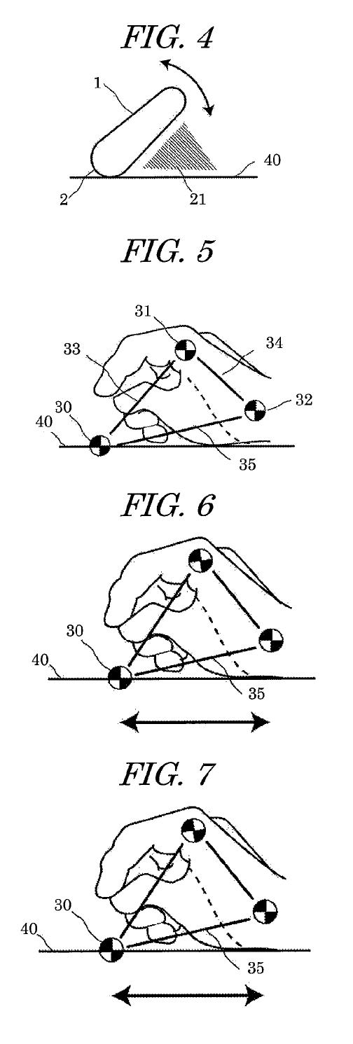

According to the above-explained mouse device of the first embodiment, as shown in FIG. 4 that is a conceptual diagram, since the bottom face of the sliding portion 2 retaining the sensor thereinside is a convex surface, the grip portion 1 can freely tilt, resulting in an increase of the slidable range in the back-and-forth direction.

More specifically, as shown in FIG. 5, in a triangle having a B point 31 (a PIP joint) as a vertex and interconnecting a C point 32 (a wrist joint) and an A point 30 (a sliding sensor) on a plane, since a length 34 (a side Y) of a palm and a length 33 of the grip portion 1 of the mouse device remain same, in general, the angle of the A point 30 and the length of a Z side 35 (a bottom side) should be variable in order to move the A point 30 back and forth. According to the present invention, however, since the grip portion 1 is tiltable based on the A point 30 and there is the movable space 21 between the palm and the mouse device as shown in FIG. 4, the slidable range in the back-and-forth direction is remarkably extended as shown in FIGS. 6 and 7.

Moreover, since the grip portion 1 and the sliding portion 2 configure a tumbler doll configuration, the grip portion 1 stands up to return to an upright position, and the mouse device can be gripped quickly at the time of starting of an operation. Accordingly, an exchanging of an operation with other operations including a keyboard operation becomes comfortable through a single step.

Furthermore, since the grip portion 1 is supported by the sliding portion 2 on the sliding plane 40 or is distributingly supported by a hand, the click button 4, etc., becomes stable, and the user can operate the mouse device in a relaxed condition. In addition, since the battery or the weight 6 is disposed at a lower position, the weighted center is located at the lower side, and the upper end of the grip portion 1 is in a shape that can be supported by the side around the PIP joint 61 of the index finger, a stable operation is realized.

Still further, since the click button 4 and the scroll wheel 5 are disposed so as to be symmetrical in the horizontal direction, the user does not feel any difference in the operating feeling even if the user operates the mouse device with either of the right hand and the left hand unlike the conventional mouse devices having the click buttons disposed in the horizontal direction, thereby accomplishing a high convenience.

### 2. Second Embodiment

### [2.1 Configuration]

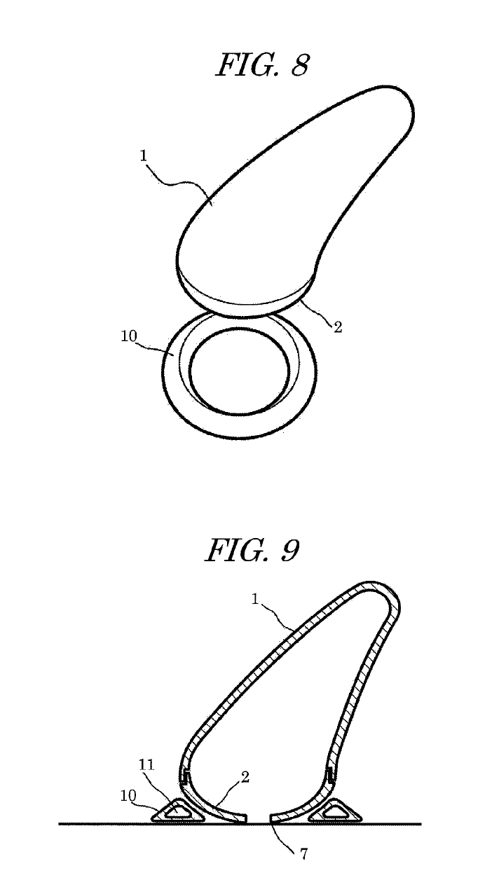

Next, an explanation will be given of a configuration of a mouse device according to a second embodiment of the present invention with reference to FIGS. 8 and 9. The basic configuration is same as that of the first embodiment, so that the duplicated explanation will be omitted and the same reference number is allocated.

According to the second embodiment, as shown in FIG. 8, in addition to the mouse device according to the first embodiment, a support 10 that supports the mouse device from the bottom is further provided. The support 10 is in a doughnut shape like a disc having the internal side thereof being omitted, and as shown in FIG. 9, the cross-sectional shape thereof is a chevron with an external side face and an internal side face. The external side face forms an inclined surface, and the internal side face is formed like a mortar.

More specifically, the support 10 has the internal side face that is in a shape corresponding the convex surface of the sliding portion 2, and has a thickness so that the vertex of the convex surface of the sliding portion 2 contacts the sliding plane through the through-hole of the support 10 when supporting the sliding portion 2.

Provided inwardly of the support 10 is an annular magnet 11 along the shape of the support 10. In association with this configuration, according to the present embodiment, at least the bottom face of the sliding portion 2 is formed of a material that is a magnetic material like a metal. Hence, the support 10 and the sliding portion 2 are attracted with each other by magnetic force, thereby maintaining a contacting state.

It is preferable that the magnet 11 provided inside the support 10 should have weak magnetic force which is sufficient to hold the mouse device while allowing the mouse device to slide over the support 10 when the mouse device is moved. Moreover, regarding the magnetic material used for the sliding portion 2, the whole sliding portion 2 can be formed of the magnetic material, but as explained above, it is sufficient to use the magnetic material on the area at the bottom face of the sliding portion where the sliding portion 2 directly contacts the support 10. For example, a configuration may be employed in which a magnetic sheet is pasted on the bottom face.

### [2.2 Working and Advantage]

The mouse device employing the above-explained configuration according to the second embodiment operates as follows.

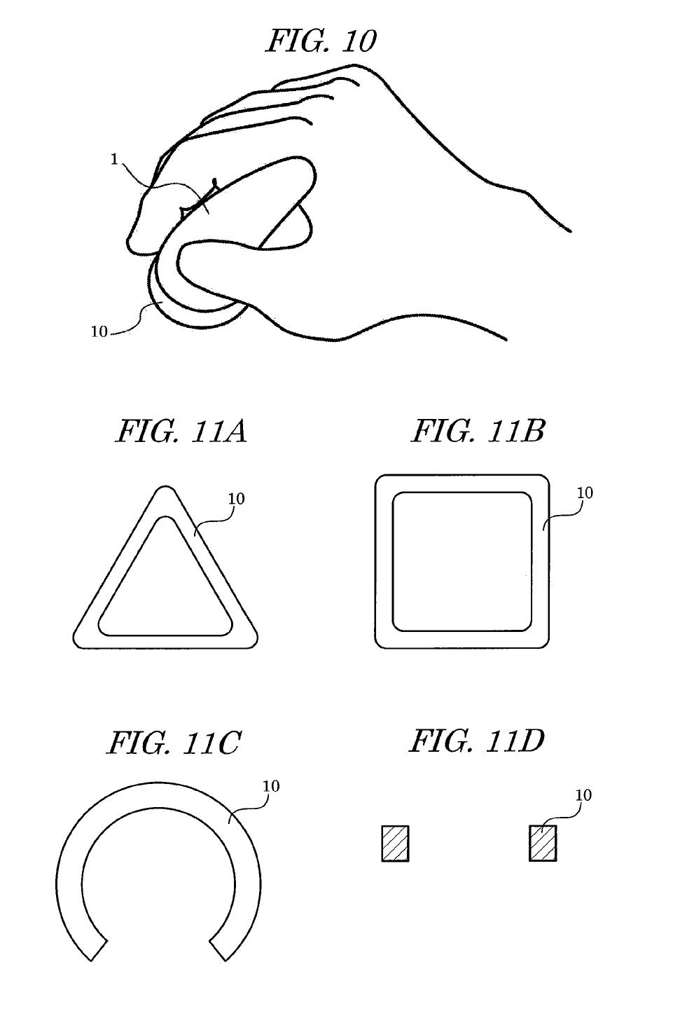

When the mouse device of the present embodiment is used, with the mouse device being mounted on and supported by the support 10, like the first embodiment, as shown in FIG. 10, the grip portion 1 is held by a fourth finger and a little finger from the lower external direction, by an index finger and a middle finger from the upper direction, and by a thumb from the lateral internal direction, and the mouse device is slid over the support 10.

That is, when the mouse device is moved backward, the sliding portion 2 is retracted in the movable range over the support 10, and when the mouse device is moved forward, the sliding portion 2 is pushed in the movable range over the support 10. Like the first embodiment, in both cases in which the mouse device is moved forward or is moved backward, the grip portion 1 is tilted. Moreover, the click button 4 and the scroll wheel 5 on the upper face are operated by the index finger and the middle finger.

When the user gives a forward or backward operation, the sliding portion 2 itself or the magnetic material provided therein is attracted by the magnet provided inwardly of the support 10, and a slight friction is applied to a tilting motion of the grip portion 1. Hence, when the user depresses or rotates the click button 4 or the scroll wheel 5 provided at the grip portion 1, it is possible to prevent a shifting of a pointing position due to an excessive tilting of the whole mouse device affected by the depression. Moreover, by a certain resistive force against the tilting motion of the grip portion 1 originating from the friction between the sliding portion 2 and the support portion 10, the user does not need to be nervous to adjust the angle of the mouse device very sensitively so as not to excessively tilt the grip portion 1 relative to the movable range of the mouse device, and is allowed to tilt the grip portion 1 relatively freely.

Moreover, when the user operates the mouse device other than the forward and backward moving operations, since the mouse device of the present embodiment employs a tumbler doll configuration that is realized by the grip portion 1 and the sliding portion 2, the mouse device basically rises by itself. However, since the whole shape thereof is a vertically long shape, it is expected that the mouse device may remain in a fall-down condition in some cases. In this point, however, according to the present embodiment, the support 10 supports a rising part from the bottom-face side of the sliding portion 2 between the vertex of the convex surface of the sliding portion 2 and the sliding plane to facilitate the mouse device to maintain the rising condition. Accordingly, an effect of preventing a fall-down of the mouse device can be expected.

According to the above-explained mouse device of the second embodiment, since the mouse device of the first embodiment can be used in a condition supported by the support 10, both stability and the readiness to a work are fine. Moreover, since the mouse device can be slid and moved on the support 10 having the inward portion eliminated, the slidable range can be ensured appropriately even in the condition in which the mouse device is supported by the support, and thus a strain for human body can be reduced.

### Other Embodiments

The present invention is not limited to the above-explained embodiments, and, for example, following modes are also within the scope and spirit of the present invention. That is, the angle of the grip portion relative to the sliding portion of the mouse device of the above-explained embodiments is not limited to the corresponding relationship therebetween shown in the figures in the above-explained embodiments. For example, the mouse device may be provided with an angle adjusting mechanism for the grip portion in order to select such an angle as needed depending on an individual difference, such as the purpose of a user, and a size of a hand thereof.

According to the second embodiment, a configuration was explained in which the magnetic material like a metal is adopted for the sliding portion 2 and the support 10 is provided with the magnet 11. The present invention is, however, not limited to such a configuration, and for example, an embodiment of an inverse configuration is included within the scope and the spirit of the present invention in which the sliding portion 2 is provided with a magnet and a magnetic material like a metal is adopted for the support 10.

According to the second embodiment, the support employs a configuration in which the cross section thereof shown in FIG. 9 is in a chevron shape defined by the external side face and the internal side face. However, this is merely an illustrative embodiment for explanation. That is, as an essential configuration of the support, as is indicated by its name, it is appropriate primarily if a rising part from the bottom-face side of the sliding portion 2 between the vertex of the convex surface of the sliding portion 2 and the sliding plane is supported by the support, and it is secondarily preferable that friction is generated between the sliding portion and the support.

Hence, according to the present invention, the support is not limited to the configuration explained in the second embodiment, and for example, as shown in FIG. 11, the planar shape of the support may be a C-shape (see FIG. 11A), a rectangle with the inward portion being eliminated (see FIG. 11B), a triangle (see FIG. 11C). In addition to such shapes, the support can be formed in other polygonal shapes, such as a pentagon, hexagon, and a star shape.

Moreover, according to the second embodiment, the support is configured to support the convex surface of the bottom face of the sliding portion, and to have an inclined surface that is the internal surface like a mortar so that the sliding portion can slide on the support. This configuration is, however, for accomplishing the above-explained secondary role of the support, and the present invention is not limited to such a configuration. That is, as shown in FIG. 11D, the support can be configured to have a cross-sectional shape with an internal outer circumference surface raised vertically.

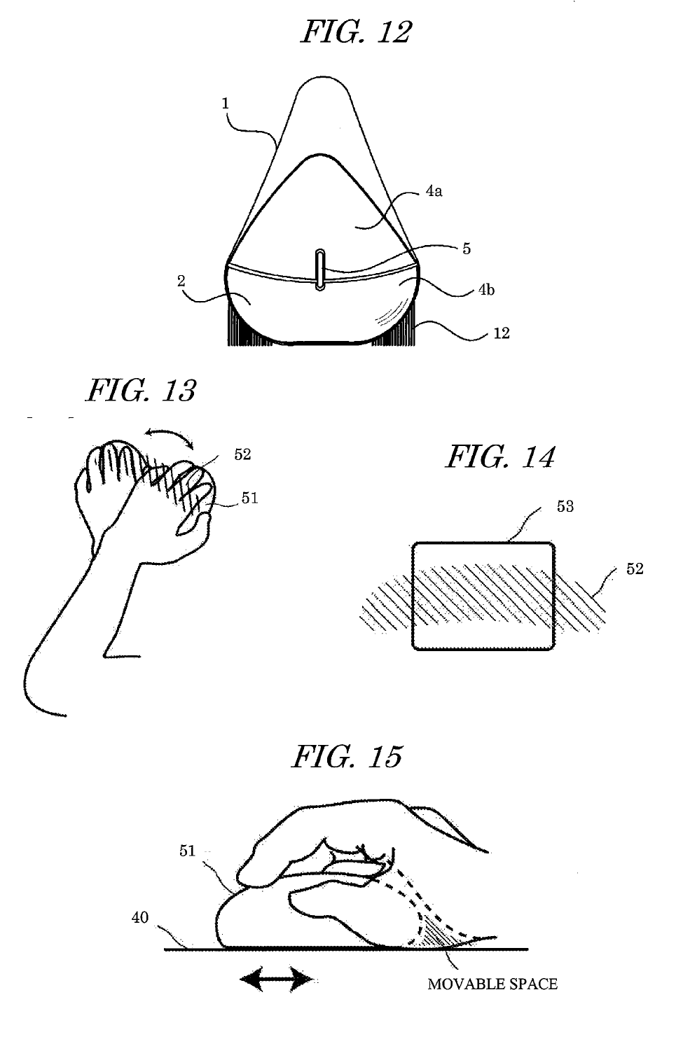

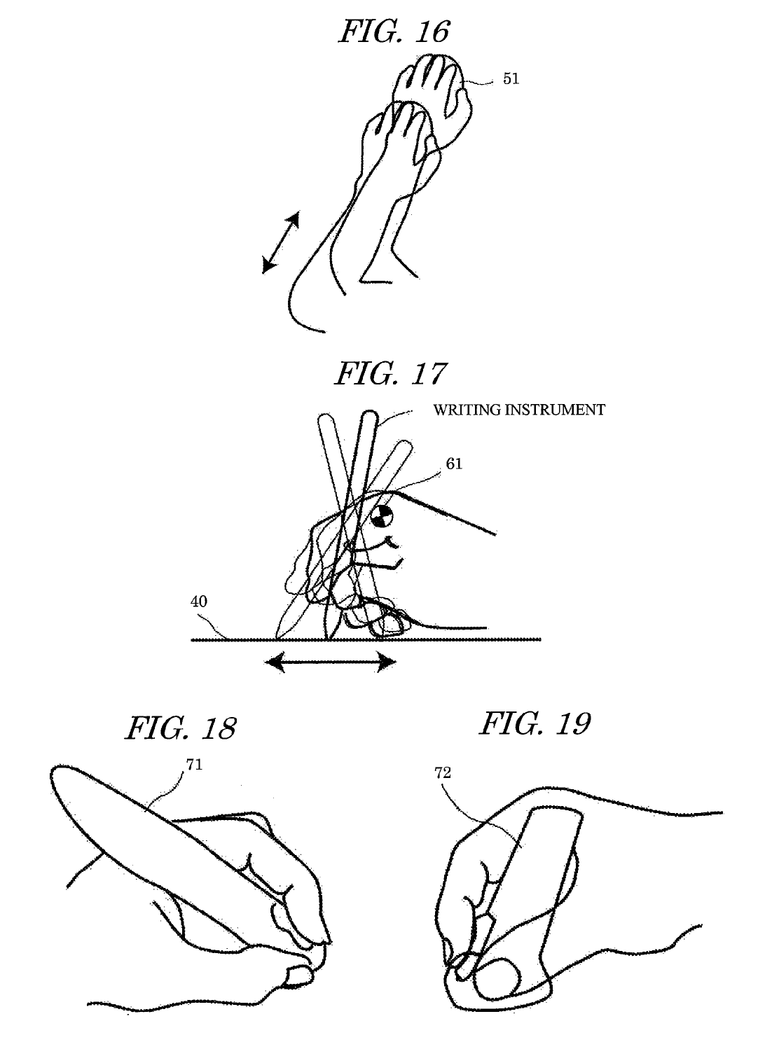

Furthermore, as a configuration that satisfies both primary and secondary roles of the support, as shown in FIG. 12, the support may be configured to have a brush portion 12 with a large number of fibers and wires, etc., which is provided at a part corresponding to the rising part of the sliding portion 2 from the bottom-face side thereof between the vertex of the convex surface of the sliding portion 2 and the sliding plane.

1. A mouse device which includes a sensor that moves a pointer displayed on a display screen and which is operated in order to move the sensor on a plane, the mouse device comprising:
a sliding portion having a convex sliding surface from which the sensor is exposed; and
a grip portion coupled to the sliding portion has and a substantially oblique conical shape.

2. The mouse device according to claim 1, wherein a weight is disposed inside the sliding portion in order to make the mouse device to return to an upright position.

3. The mouse device according to claim, wherein
the grip portion includes a click button that is depressed at an instructing position of the pointer displayed on the display screen, and
the click button is provided on a surface at an obtuse-angle side between the axis of the grip portion and the sliding surface of the sliding portion and the click button is disposed to be symmetrical relative to an axis of the surface at the obtuse-angle side in a lengthwise direction.

4. The mouse device according to claim 3, wherein
the click button comprises a first button and a second button that generate different instructions, respectively, by being depressed at an instructing portion of the pointer displayed on the display screen, and
the first button and the second button are provided side by side on the surface at the obtuse-angle side in the lengthwise direction.

5. The mouse device according to claim 1, further comprising a support which abuts and supports the sliding portion,
wherein the support is disposed to fill a gap formed between the convex sliding surface and the plane on which the sliding surface is disposed, and is provided together with or separately from the sliding portion.

6. The mouse device according to claim 5, wherein the support is formed in a surrounding shape with a through-hole,
at least a part of the surrounding shape abuts the convex sliding surface of the sliding portion, and
the position detecting sensor is disposed so as to be exposed from the through-hole toward the plane on which the sliding surface is disposed.

7. The mouse device according to claim 6, wherein an internal side face of the support is formed in a mortar shape in order to allow the convex sliding surface of the sliding portion to abut the internal side face,
the convex sliding surface of the sliding portion is formed of a magnetic material including a metal, and
the support is provided with a magnet there inside.

8. The mouse device according to claim 7, wherein the sliding portion is provided with a magnet there inside, and
the internal side face of the support is formed of a magnetic material including a metal.

9. The mouse device according to claim 7, wherein an attraction between the magnetic material and the magnet is set to be a level that allows the sliding portion to slide and move over the support.

10. The mouse device according to claim 5, wherein the support is configured by a large number of hairy materials provided at the convex surface that forms the bottom face of the sliding portion.

11. The mouse device according to claim 1, wherein a movable space of the mouse device is formed between the oblique grip portion and a plane on which the sliding surface is disposed.
